(19) United States
(12) Patent Application Publication
(10) Pub. No.: US 2025/0362272 A1
(43) Pub. Date: Nov. 27, 2025

(54) METHOD AND SYSTEM FOR DETECTING DEFECTS ON REMOTE INFRASTRUCTURE

(71) Applicant: CRWN.AI Ltd., Kelowna (CA)

(72) Inventors: Jozsef Hamari, Kelowna (CA); Cameron Newton, Kelowna (CA); Fangrui Liu, Beijing (CN); Zheng Liu, Kelowna (CA)

(73) Assignee: CRWN.AI Ltd., Kelowna, BC (CA)

(21) Appl. No.: 18/871,909

(22) PCT Filed: Jun. 8, 2023
(86) PCT No.: PCT/CA2023/050790

§ 371 Date: Dec. 5, 2024

Related U.S. Application Data
(60) Provisional application No. 63/350,532, filed on Jun. 9, 2022.

(30) Foreign Application Priority Data
Jun. 9, 2022 (CA) 3162298

(51) Int. Cl. G01N 29/14; G01N 29/44; G06N 3/0455

(52) U.S. Cl. CPC G01N 29/14; G01N 29/4445; G01N 29/4481; G06N 3/0455

(57) ABSTRACT

Methods and systems for detecting conditions on remotely located infrastructure assets include: recording audio signals emitted by an asset using a sensor device proximate the asset; transforming the recorded audio signals into a spectrogram, the transformation performed by an edge computing device proximate the asset; encoding the spectrogram to generate a binary feature representation of the recorded audio signal, the encoding performed by the edge computing device using an encoder component of an autoencoder; transmitting the binary feature representation to a remote computing system located remotely from the asset; decoding the binary feature representation so as to regenerate the spectrogram, the decoding performed by the remote computing system using the decoder component of the autoencoder; and classifying a latent variable space of the regenerated spectrogram to detect whether the recorded audio signals indicate a condition of the asset, the classifying performed by a classifier hosted on the remote computing system.

### RELATED APPLICATIONS

This application claims the benefit of PCT Application No. WO/2023/235981; U.S. Provisional Application No. 63/350,532; and Canadian Patent Application No. 3,162,298, each of which are incorporated herein by reference.

### FIELD

The present disclosure relates to the identification of incipient faults on infrastructure, including but not limited to electrical transmission, distribution and/or substation infrastructure, and the compression and transmission of the resultant data.

### BACKGROUND

The generation, transmission, and distribution of electricity involves a complex system of infrastructure, comprising hardware that electrically insulates the high voltage electricity transmitting through the infrastructure from grounding sources, thereby safeguarding the public from injury or death. Such electrical infrastructure undergoes stress from various causes, including environmental degradation, physical stress and strain, and electrical stress from the high voltages carried on the electrical conductors. The stress associated with operation, over time, causes the infrastructure (including conductors, insulators, and switch-gear) to incur different types of damage and degradation. Monitoring the rate and extent of damage to electrical infrastructure is therefore important to utility operators, as the failure of this hardware can lead to catastrophic events for which the operator may be held responsible. Furthermore, regular maintenance or replacement of degraded or failing electrical infrastructure is required for maintaining consistent and reliable delivery of electricity to the utility's customers.

There are many forms of damage and degradation which affect switch-gear, insulators, and conductors over years of operation. Some examples of damage and degradation include physical destruction, partial discharge and corona discharge. Corona discharge is a phenomenon that occurs when there is a localized discharge of electrical energy causing the ionization of surrounding air molecules. Corona discharge may occur in degraded insulators, conductors, and switch-gear on transmission, distribution, and substation hardware. Corona discharge may also cause the further deterioration of the hardware components, and may eventually lead to their catastrophic failure if not addressed in a timely manner. The task of detecting corona discharge and other physical damage on electrical transmission and distribution infrastructure is impeded by a number of obstacles. Firstly, infrastructure assets may typically be located in remote areas which are difficult to access for the purpose of regularly monitoring the status of those assets. Secondly, it is difficult to accurately classify the defects of the different pieces of hardware that comprise the electrical infrastructure assets, based on signals emitted by those assets during operation. Additionally, there is a lack of baseline data related to corona discharge and other hardware defects. At present, detection and classification of corona discharge in industrial applications is typically performed by sending an operator into the field, to collect data from the individual assets using a handheld sensorto record and/or image the hardware in question, and to make an on-site diagnosis based on the physical appearance of the hardware along with the sensor readings recorded. For example, under normal conditions, insulators, switch-gear, and conductors will emit an audible noise similar to a crackling sound. When the hardware has been damaged or degraded, there are characteristic patterns which embed themselves into the sound signals emitted by the hardware, which typically occur in the ultrasonic audio bands. Sensors are used to detect and record these sound signals and these recordings may be kept in a database to be analyzed at a future date, but often, the recordings are discarded and the detailed information contained therein is summarized into high level recommendations for repair or replacement of the monitored hardware (herein, “hardware” and “assets” are used interchangeably).

This issue is compounded by the fact that electrical transmission assets often exist in areas far from urban centers, making it difficult and impractical to access such remote assets for assessment purposes. As a result, helicopters and drones are often utilized to access the most remotely located assets. Furthermore, many such locations do not have cost-efficient access to conventional data networks including cellular, satellite or wired network, which limits the ability to strap a sensor to the hardware and remotely collect audio signals emitted by the hardware and then transmit the collected data to a central server for analysis. Such challenges result in the inconsistent and suboptimal monitoring of electrical infrastructure. The absent or infrequent monitoring of these remote assets may subsequently lead to catastrophic failures, which for example may ignite a forest fire if the asset is located in a forested area. The damage caused by catastrophic failure of electrical infrastructure assets may be amplified by the remote location of such assets from emergency service response centers.

Other examples of infrastructure assets that degrade over time and eventually fail include pipelines, oil and gas related assets, transportation infrastructure including tunnels, and overpasses, roadways, railway systems and roadway lighting systems. In the example of pipelines for transporting oil, liquified natural gas, and similar products, the corrosion of pipelines over a period of time may result in pipeline leakage. Additionally, from time-to-time individuals may intentionally damage such infrastructure. Because pipelines are underground and may typically run for thousands of kilometers, it is challenging to consistently test and monitor the entire network of pipelines in order to detect the condition of the pipeline and predict when a failure may occur or detect that a failure has occurred. Similar challenges are presented by infrastructure assets that are linear in nature, in that such infrastructure often includes a network of infrastructure assets that extend over hundreds or thousands of kilometers and into areas located remotely from urban centers, where cost-efficient access to conventional data networks may be lacking. Because this infrastructure often covers a large area, and is often located far away from populations, it is difficult to adequately monitor the condition and functioning of such assets to determine when maintenance or replacement is required, or when failure of the asset is imminent. Not only is it difficult to physically access such assets for monitoring, due to the remote location of such assets, it is also challenging to use sensors or other devices to monitor these assets, because they are often located in areas that do not have adequate telecommunication network coverage, which would allow for the transfer of detected signals to a centralized location where the assets are being monitored.

It is desirable for improved methods and systems for monitoring the condition and status of remotely located infrastructure assets, such as electrical transmission lines and related infrastructure, in order to detect when maintenance or repair is required in order to avoid failure of such assets and limit or prevent the impact of such failure on the assets and the surrounding environment.

### SUMMARY

There exist different algorithm types in the deep learning discipline that are capable of classifying anomalies in sound signals. For example, Convolutional Neural Networks (“CNNs”) have been utilized for image classification in different applications and are viable candidates for classifying spectrograms that are produced from time-sliced frequency transforms on the recorded, one-dimensional audio data. However, CNNs are limited by the intensity of their computation; their deployment on the sensor/computer (otherwise referred to herein as the “edge computing device”) that is attached to the asset is impractical because of the significant power source requirement. An alternative approach would be to transmit the raw data recorded by the sensor to a processing server for classification. However, an issue with transmitting the raw data is the constrained network bandwidth available in the remote areas where the assets to be monitored are typically located. The challenges presented by collecting and analysing real-time data for monitoring the status of remotely-located electrical infrastructure assets include the lack of a power source for energizing the sensor device and the computing device attached to the electrical asset being monitored; analyzing and classifying the collected data to accurately detect faults, defects or equipment failures; and the scarcity of sufficient network bandwidth for transmitting the collected sensor data to a central location for processing and analysis. Recording signals collected by the sensors, and then processing and classifying the resulting data, requires a significant power budget and computing resources.

In an aspect of the present disclosure, “edge computing,” which is a term describing the paradigm of computing closer to the site of data collection at the network edge, is utilized to solve the issue of constrained network bandwidths at the cost of a higher power budget. The balance of edge computation with power constraints is adjusted with the advancement of low power system on chip (“SOC”) devices and the development of higher capacity batteries that allow for more stable remote power deployments. However, edge computing devices may nevertheless have hardware constraints that traditional servers or other computers, that are purpose-built for artificial intelligence applications, do not have. Therefore, the Applicant has scaled down the artificial intelligence (“AI”) algorithms deployed on the edge computing devices, to reduce the edge computing device's hardware and power requirements. As a result, a reduced-size, artificial intelligence model that captures the significant features of the input data is deployed on the edge computing device, rather than running the full classification algorithm on the edge computing device.

For example, in some embodiments an autoencoder AI model (also referred to herein as the “autoencoder”) comprises two components; the first component is the encoder that maps the raw input data to a latent variable space, and then compresses the data into a binary representation; and the second component is the decoder that decompresses the binary representation, and then maps the latent representation into a reconstruction of the input data. The encoder, which is deployed on the edge computing device, may be used to compress the input data to a size that meets the network constraints, and the compressed data may then be delivered to a centralized server or other computing device or system located remotely from the electrical assets, where computing and power resources are less constrained. At the remote computing system, the binary representation may be decoded by the decoder component back into a representation of the original input data. The representation of the original input data may then be run through a classifier AI model on the remote computing system to classify the latent variable space and identify any faults, defects or other conditions of the asset, as indicated in the recorded input data.

In summary, the systems and methods described herein utilize a computer paradigm wherein computation at the edge of the network, where the electrical assets (or other types of infrastructure assets, such as pipelines) being monitored are located, is optimized to allow for the smallest deployment of computer hardware at the asset itself. This is accomplished by utilizing compression and transmission of the captured data to a centralized server, at a location remote from the assets being monitored. At the remotely located, centralized server, full classification Al models are run on computer hardware that is not limited by the computing and power constraints of the edge computing device.

In one aspect of the present disclosure, a method for detecting a condition on infrastructure comprising a plurality of assets is provided. The method comprises the steps of: recording audio signals emitted by an asset of the plurality of assets using a sensor device mounted proximate to the asset; transforming the recorded audio signals into a spectrogram, the transforming step performed by an edge computing device mounted proximate to the asset; encoding the spectrogram to generate a binary feature representation of the recorded audio signals, the encoding step performed by the edge computing device using an encoder component of an autoencoder, wherein a decoder component of the autoencoder is located on a remote computing system located remotely from the asset; transmitting the binary feature representation to the remote computing system; decoding the binary feature representation to regenerate the spectrogram, the decoding step performed by the remote computing system using the decoder component of the autoencoder; classifying a latent variable space of the regenerated spectrogram to detect whether the recorded audio signals indicate a condition of the asset, wherein the classifying step is performed by a classifier hosted on the remote computing system.

In some embodiments, the step of encoding the spectrogram to generate a binary feature representation further includes the encoder converting the spectrogram into the latent variable space, the latent variable space representing features of the recorded audio signals, and then the encoder encodes the latent variable space into the said binary feature representation.

In some embodiments, the method further comprises a step of training the autoencoder on the remote computing system using a data set, the data set comprising a plurality of audio signal recordings obtained from the plurality of assets. The method may further comprise a step of training the classifier using the data set, wherein each audio signal recording of the plurality of audio signal recordings is labelled with a condition of interest, the condition of interest indicating a condition of the asset that emitted the audio signal.

In some embodiments, the step of training the autoencoder generates a plurality of autoencoder models for encoding and decoding the audio signal and the step of training the classifier generates a plurality of classifier models. After performing the steps of training the autoencoder and training the classifier, the method further includes performing a validation step wherein the autoencoder and the classifier are trained together on the data set to identify a combination of an autoencoder model of the plurality of autoencoder models and a classifier model of the plurality of classifier models that produces a most accurate identification of the condition of the asset emitting the audio signal.

In an aspect of the present disclosure, after the step of training the autoencoder, the encoder component of the autoencoder is deployed on the edge computing device and the decoder component of the autoencoder is deployed on the remote computing system. In some embodiments, the remote computing system comprises a training server and a deployment server. The steps of training the autoencoder and training the classifier may be performed on the training server, and the decoder component of the autoencoder and the classifier may be deployed on the deployment server.

In another aspect of the present disclosure, the autoencoder comprises a first series of convolutional neural networks (CNNs). In another aspect, the classifier comprises a second series of CNNs.

In some embodiments, the asset is selected from a group of electrical infrastructure assets, the group comprising: switch-gear, insulator, conductor, sub-conductor. The condition of interest, in some embodiments, is selected from a group comprising: physical failure, corona discharge, partial discharge, arcing, flashover, pollution, nominal condition. In some embodiments, the infrastructure is selected from a group comprising: electrical transmission infrastructure, electrical distribution infrastructure, electrical generation infrastructure, electrical substation infrastructure, transportation infrastructure, tunnels, roadways, overpasses, bridges, roadway lighting systems, traffic control systems, pipeline infrastructure, oil and gas infrastructure, railway systems.

In another aspect of the present disclosure, the sensor device comprises: a microphone for receiving the audio signals and a memory for recording the received audio signals. In some embodiments, the microphone is an analog microphone and wherein the sensor device further comprises an analog to digital converter for converting the received analog audio signals into digital signals. In some embodiments, the microphone comprises a microphone array, and each microphone in the microphone array is configured to receive an audio signal emitted by a sub-component of the asset.

In some embodiments, the step of transmitting the binary feature representation to the remote computing system comprises transmitting the binary feature representation by a low-power wireless transmitter over a wireless network. In some embodiments, the method further comprises a step of generating a recommendation for maintenance of the asset based upon the classification of the latent variable space of the regenerated spectrogram. In some embodiments, the method further comprises the steps of generating a recommendation for maintenance of each asset of the plurality of assets based upon the classification of the latent variable space of the regenerated spectrogram so as to generate a plurality of recommendations for maintenance of the plurality of assets; and ranking the plurality of recommendations for maintenance to prioritize the recommendations based on an assessed criticality of the identified condition of each asset of the plurality of assets. In some embodiments, the method further comprises a step of implementing the prioritized maintenance recommendations on the identified assets of the plurality of assets.

In another aspect of the present disclosure, a method for detecting a condition on infrastructure comprising a plurality of assets is provided. The method comprises the steps of: obtaining recorded audio signals emitted by an asset for further processing by an edge computing device mounted proximate to the asset; transforming the recorded audio signals to generate a spectrogram, the transforming step performed by the edge computing device; encoding the spectrogram to generate a binary feature representation of the recorded audio signal, the encoding step performed by the edge computing device using an encoder component of an autoencoder, wherein a decoder component of the autoencoder is located on a remote computing system located remotely from the asset; transmitting the binary feature representation to the remote computing system; decoding the binary feature representation to regenerate the spectrogram, the decoding step performed by the remote computing system using the decoder component of the autoencoder; and classifying a latent variable space of the regenerated spectrogram to detect whether the recorded audio signals indicate a condition of the said asset, wherein the classifying step is performed by a classifier hosted on the remote computing system.

In an aspect of the present disclosure, the step of encoding the spectrogram to generate a binary feature representation further includes the encoder converting the spectrogram into the latent variable space, the latent variable space representing features of the recorded audio signals, and then the encoder encodes the latent variable space into the said binary feature representation.

In some embodiments, the method further includes the step of training the autoencoder on the remote computing system using a data set, the data set comprising a plurality of audio signal recordings obtained from the plurality of assets. Some embodiments include the step of training the classifier using the data set, wherein each audio signal recording of the plurality of audio signal recordings is labelled with a condition of interest, the condition of interest indicating a condition of the asset that emitted the audio signal. In some embodiments, the step of training the autoencoder generates a plurality of autoencoder models for encoding and decoding the audio signal and wherein the step of training the classifier generates a plurality of classifier models. After performing the steps of training the autoencoder and training the classifier, a validation step is performed wherein the autoencoder and the classifier are trained together on the data set to identify a combination of an autoencoder model of the plurality of autoencoder models and a classifier model of the plurality of classifier models that produces a most accurate identification of the condition of the asset emitting the audio signal.

In some embodiments, after the step of training the autoencoder, the encoder component of the autoencoder is deployed on the edge computing device and the decoder component of the autoencoder is deployed on the remote computing system.

In another aspect of the present disclosure, the remote computing system comprises a training server and a deployment server, and wherein the steps of training the autoencoder and training the classifier are performed on the training server, and wherein the decoder component of the autoencoder and the classifier are deployed on the deployment server.

In some embodiments of the present disclosure, the autoencoder comprises a first series of convolutional neural networks (CNNs). The classifier, in some embodiments, comprises a second series of CNNs.

In some embodiments, the asset is selected from a group of electrical infrastructure assets, the group comprising: switch-gear, insulator, conductor, sub-conductor. In some embodiments, the condition of interest is selected from a group comprising: physical failure, corona discharge, partial discharge, arcing, flashover, pollution, nominal condition. In some embodiements, the infrastructure is selected from a group comprising: electrical transmission infrastructure, electrical distribution infrastructure, electrical generation infrastructure, electrical substation infrastructure, transportation infrastructure, tunnels, roadways, overpasses, bridges, roadway lighting systems, traffic control systems, pipeline infrastructure, oil and gas infrastructure, railway systems.

In another aspect of the present disclosure, the step of transmitting the binary feature representation to the remote computing system comprises transmitting the binary feature representation by a low-power wireless transmitter over a wireless network. In some embodiments, the method further comprises a step of generating a recommendation for maintenance of the asset based upon the classification of the latent variable space of the regenerated spectrogram. In some embodiments, the method further comprises the steps of generating a recommendation for maintenance of each asset of the plurality of assets based upon the classification of the latent variable space of the regenerated spectrogram so as to generate a plurality of recommendations for maintenance of the plurality of assets; and ranking the plurality of recommendations for maintenance to prioritize the recommendations based on an assessed criticality of the identified condition of each asset of the plurality of assets.

In some embodiments, the method further comprises a step of implementing the prioritized maintenance recommendations on the identified assets of the plurality of assets.

In another aspect of the present disclosure, a system for detecting a condition on infrastructure, the infrastructure comprising a plurality of assets, comprises: a sensor device mounted proximate to the asset, the sensor device configured to record audio signals emitted by an asset of the plurality of assets; an edge computing device mounted proximate to the asset, the edge computing device configured to transform the recorded audio signals into a spectrogram and then encode the spectrogram to generate a binary feature representation of the recorded audio signal using an encoder component of an autoencoder; a remote computing system located remotely from the asset, the remote computing system configured to receive the binary feature representation transmitted from the edge computing device over a network and then decode the binary feature representation to regenerate the spectrogram, the decoding step performed by the remote computing system using the decoder component of the autoencoder; the remote computing system additionally configured to classify a latent variable space of the regenerated spectrogram to identify whether the recorded audio signals indicate a condition of the asset, wherein the classifying step is performed by a classifier hosted on the remote computing system.

In some embodiments of the system, the encoder converts the spectrogram into the latent variable space, the latent variable space representing features of the recorded audio signals, and then the encoder encodes the latent variable space into the binary feature representation. In some embodiments, the autoencoder comprises a first series of neural networks (CNNs) and wherein the encoder component of the autoencoder contains fewer CNNs than the decoder component of the autoencoder. In some embodiments, the classifier comprises a second series of CNNs.

In another aspect of the present disclosure, the remote computing system may comprise a training server and a deployment server, and wherein the training of the autoencoder is performed on the training server and the decoder component of the autoencoder and the classifier are deployed on the deployment server. In some embodiments of the system, the edge computing device comprises a low-power wireless transmitter, and wherein the binary feature representation is transmitted to the remote computing system by the low-power wireless transmitter over a wireless network. In some embodiments, the sensor device comprises: a microphone for receiving the audio signals and a memory for recording the received audio signals. In some embodiments, the microphone is an analog microphone and wherein the sensor device further comprises an analog to digital converter for converting the received analog audio signals into digital signals. In some embodiments, the microphone comprises a microphone array, and wherein each microphone in the microphone array is configured to receive an audio signal emitted by a subcomponent of the asset.

### BRIEF DESCRIPTION OF THE DRAWINGS

FIG. 1 is a schematic diagram depicting a layout of the sensor device and the high voltage electrical infrastructure assets being monitored by the sensor device, in an illustrative example of the present disclosure.

FIG. 2 is a schematic diagram depicting the steps of collecting audio data emitted by the electrical infrastructure assets of FIG. 1 and the subsequent transformation and compression of that data into a binary representation.

FIG. 3 is a schematic diagram depicting a data transmission system that sends the binary representation of FIG. 2 to a wireless access point.

FIG. 4 is a schematic diagram depicting a data decompression and classification system that decodes the binary representation and subsequently identifies a classification label for the data.

FIG. 5 is a schematic diagram depicting transmission of binary data over a wireless network for processing on a server. FIG. 6 is a schematic diagram depicting the training of deep learning models on the training server and deployment to the edge computing device and the deployment server.

### DETAILED DESCRIPTION

Sound is a vibration, or wave, which propagates through a medium. Typically, sound waves of a given frequency propagate through the air and are perceived when received by the ear of an animal or human. The range of sound wave frequencies which are detectable by humans, for example, is typically between 20 Hz and 20 kHz; this range is sometimes referred to as the “audible range” of sound waves. Ultrasound includes sound waves having a frequency greater than 20 kHz and are typically not perceptible to the human ear. In addition to ears, which are a biological structure for receiving sound waves, other receivers (also referred to herein as “sensors”) include microphones, which receive and transform the sound wave into an electric signal. The electric signal may be recorded to a memory storage device, including but not limited to a disc, a hard drive, a flash drive, or any other memory storage device as would be known to a person skilled in the art. As used herein, the term “audio signal” refers to any type of signal associated with sound, including but not limited to a sound wave, as well as an electric signal and any other digital or analog representation of a sound wave. Recorded audio signals are herein referred to as “data”.

It is known that infrastructure assets, including but not limited to electrical transmission infrastructure assets, emit sound waves at different frequencies and in different patterns. The applicant has determined that the audio signals, emitted by different assets or structures, may be analysed to identify patterns in those audio signals which contain information about the condition, status and operation of such assets. By recording the audio signals emitted by infrastructure assets and analysing that recorded audio data, utilizing trained classification Al models, the applicant is able to detect problems developing on remote infrastructure assets that indicate the asset may fail or has failed, which allows for remote monitoring of such infrastructure assets. Advantageously, in one aspect of the present disclosure, the classification Al models may be trained and configured to not only identify a particular problem or condition developing on an asset, but also to assess the severity of the developing problem or condition, thereby allowing for the categorization of such problems or conditions in order of assessed criticality. By identifying which assets have the most severe problems or conditions developing, it is possible to prioritize the maintenance or repair of those assets, and thereby maintain or repair the assets assessed as most critical for repair or replacement, before failure occurs. In the present application, the illustrative example of electrical transmission infrastructure is used to describe aspects of the present disclosure in detail. However, it will be appreciated that the example of electrical transmission infrastructure is not intended to be limiting, and that the same methods and systems may be applied to the remote monitoring of the condition of any other infrastructure assets that emit sound waves, provided the sound waves contain information about the condition of the asset emitting the sound waves. Such infrastructure may include, but is not limited to, electrical distribution infrastructure, electrical generation infrastructure, electrical substation infrastructure, transportation infrastructure such as tunnels, roadways, overpasses, bridges and roadway lighting systems, traffic control systems, pipeline infrastructure, oil and gas infrastructure and railway systems.

In addition to the sensors picking up audio signals that are emitted by the infrastructure asset itself, with the audio signal embedding information about the condition of that asset, the methods and systems disclosed herein may also be able to detect audio signals emitted by other objects, persons or animals near the asset. For example, not intended to be limiting, a sensor mounted to a road light may pick up audio signals from a gunshot nearby, or when a vehicle crashes into the road light pole. As another example, a sensor mounted to a tunnel or an overpass may be able to detect audio signals resulting from ice or snow buildup or a birds nest located proximate the tunnel or overpass.

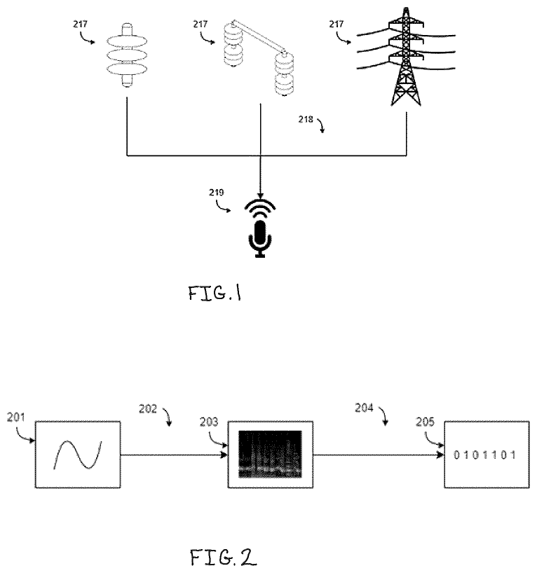

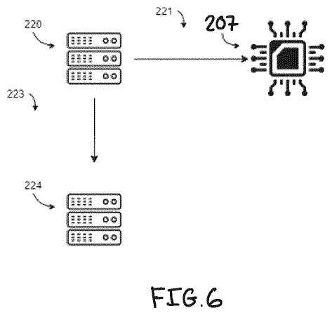

With reference to FIGS. 1-6, a sensor, such as a microphone 206, is mounted proximate to an electrical asset 217. Electrical assets 217 may include, for example, an insulator, high voltage switch, a conductor or a sub-conductor. Such high voltage electrical assets 217 emit a sound signal 218, which signal 218 is sensed by the sensor device 219 as depicted in FIG. 1. As discussed above, the sound signals 218 emitted by an asset may be in the ultrasound range and/or in the audible range.

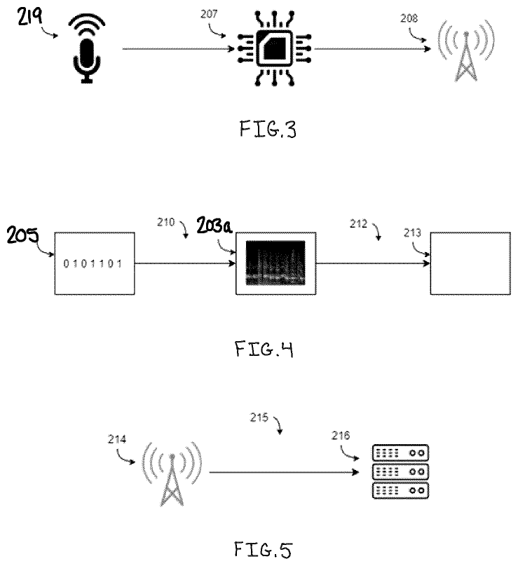

The one-dimensional (“ID”) signal is recorded through the sensor device, which device may include a microphone, and a computer processor. In some embodiments, the sensor device may include an analog microphone; the sensor device may additionally include an analog to digital converter. The sensor device is mounted proximate to the electrical hardware 217. In one example, the sensor 219 may have a frequency response of at least 48 kHz, corresponding to the upper end of the known spectrum of corona related signals 218. The signals 218 related to partial discharge, arcing, flashover and other physical defects may typically be found within the 0 to 48 KHz frequency bands. As shown in FIGS. 2 and 3, the signals 218, captured and recorded by the sensor device 219 as ID audio data 201, are subsequently transformed 202 into a two-dimensional (“2D”) frequency space representation 203 using a time slicing frequency transformation 202, such as a fast Fourier transform. The output of this transformation is a 2D image described as a spectrogram, being the visualization of the intensity of frequencies at given time intervals of an audio signal.

The resulting 2D spectrogram 203 is then processed by the encoder component 204 of the autoencoder. The autoencoder may be a first series of CNNs and fully connected layers that transform the 2D spectrogram into a series of latent variables that represent the features included in the original data. The final layer of the encoder 204, in some embodiments, is a binary neuron quantization layer that takes the latent variables and encodes them into a binary representation 205 that may be transmitted across a communication network to a remote computing system, which may include, for example, one or more centralized servers. The encoder component 204 is paired with the decoder component 210, which decoder component uses transposed convolution layers to reconstruct the original spectrogram from the latent variables. The decoder 210, which is deployed on the remote computing system, may then parse the binary representation 205 back into the latent variables for transposed convolution. The two parts of the autoencoder, with the encoder portion deployed on the edge computing device 207 and the decoder portion deployed on the centralized server 216, enable compression and then decompression of the input audio signals. Advantageously, this allows for a lower computation requirement on the edge computing device, which in some embodiments, only performs the steps of: transforming the raw audio signal data into a 2D spectrogram; encoding the 2D spectrogram to transform the 2D spectrogram into a series of latent variables; encoding the latent variables into a binary representation, thereby compressing the data for transmission to the remote computing system where the centralized server or servers is located. These encoding steps have a lower computation requirement, requiring less power and computing resources, as compared to deploying a full classification AI model on an edge computing device.

The autoencoder may be trained in conjunction with a supervised classifier to identify the features of the spectrogram which most accurately predict incipient faults in the electrical hardware 217. The classifier may comprise a second series of CNNs and fully connected layers that transform the original input data, comprising audio signals emitted by the asset being monitored, into a classification label. The classification label represents the deep learning algorithm's determination of what the original data represents. First, the classifier is trained to identify the best classifier model by providing it with labelled samples of audio signals emitted by infrastructure assets of interest, and adjusting the weights of the model by utilizing, for example, a loss function. The classifier is trained many times to look for the best classification result. For example, the best classification result may, in one aspect, be the classifier model that obtains the most accurate identification of the condition of the asset, such that the classification label applied to an audio signal by the classifier model represents an accurate identification that, for example, a corona discharge is occurring on an insulator, or a conductor is identified as having a nominal condition, meaning that there are no defects or degradation detected on that conductor.

Similarly, the encoder and decoder of the autoencoder are trained together to identify the best combination of models for encoding, compressing and then decompressing and reconstructing the original input data. The encoder and decoder are trained many times to generate a plurality of models capable of encoding and decoding the original input data. Once the autoencoder and the classifier training is completed, a validation step may be performed to identify the combination of autoencoder models and classifier models that produce the most accurate results for encoding and decoding the original input data and then classifying the input data to predict, for example, that an equipment failure is developing and needs to be addressed, which may also include accurately identifying the type of failure that has occurred, or is developing. In some embodiments, the first and/or second series of CNNs may include cascaded CNNs.

In some embodiments, the remote computing system may comprise separate deployment and training servers, wherein the training and validation steps may be completed on the training server 220, separate from the deployment server 224. The resulting encoder portion of the autoencoder model 221, obtained from the training server 220, may be deployed to the edge computing device 207 for processing at the edge of the network. The resulting decoder portion of the autoencoder and the classifier models 223 would be transferred to the deployment server 224 for the processing of the latent variables on that server.

The autoencoder is trained to identify latent variables that represent features of interest in the original audio signal data, which features of interest are then processed and analysed by the classifier model. The spectrogram generation and encoder processing steps are performed on the edge computing device 207. The resultant binary feature representation 205 is then sent through a communication network, such as the wireless communication network 215, to a processing server 216, which may in some embodiments be the deployment server 224. The wireless communication network may include LPWAN, cellular, satellite, bluetooth, and/or WIFI. The processing server then decodes the binary data 205 back into a spectrogram 203a using the model 223, trained through the process described above. The resulting spectrogram 203a is then passed to a classifier model 223 that processes the input data. The resultant classification label is then used to identify the condition of the asset based on the original audio signals emitted by the asset.

As will be appreciated by a person skilled in the art, satellite and cellular networks may provide greater bandwidth for the wireless transmission of large volumes of data, as compared to other wireless networks such as LPWAN or Bluetooth. However, compression of the recorded audio signal data, prior to wireless transmission, may still confer reduced cost benefits. For example, the cost of using satellite or cellular networks may be determined by the volume of data transmitted over those networks; therefore, reducing the size of the data packages to be wirelessly transmitted via satellite or cellular networks, via the encoding and compression techniques described above, would reduce the cost of data transmission.

Notably, the computing and power resources required to perform the spectrogram generation and encoding steps are much less, relative to the computing and power resources required to perform the full classification steps. As an illustrative example, not intended to be limiting, the first set of CNNs, comprising the autoencoder, may include four or five layers, whereas the second set of CNNs, comprising the classifier, may include eighteen to twenty layers. Thus, in the Applicant's view, it is feasible to design an edge computing device that is solar powered and is capable of performing the transformation and encoding steps, as well as transmitting the resulting binary representation to a remotely located computing device, due to the reduced size of the encoder component of the autoencoder model requiring less power and computing resources.

In one aspect, the Applicant has observed that performing the step of transforming the raw ID audio signal data into a 2D spectrogram, and then encoding the 2D spectrogram to generate the compressed binary representation of the data prior to data transmission, is preferable to merely compressing the ID audio data with an encoder to generate the compressed binary representation of the data. The Applicant has tested the approach of directly compressing the ID audio signal data, using an encoder, to generate the binary representation, transmitting the resulting binary representation to a remote computing system, decompressing the binary representation to reconstruct the original ID audio signal recording, and then subsequently performing the transformation step on the reconstructed ID audio signal recording to generate the 2D spectrogram for further analysis by the classifier. However, the Applicant found that the resulting classification of the latent variable space, generated by this method, was less accurate as compared to the method of performing the transformation of the ID audio signal data to the 2D spectrogram, and then encoding and decoding the 2D spectrogram. The Applicant theorizes that relevant data may be lost when an autoencoder model is applied directly to the raw ID audio signal recording, as compared to applying the autoencoder model to the transformed 2D spectrogram of the ID audio signal recording.

In some embodiments of the present disclosure, data relevant to the condition and status of the plurality of electrical assets that comprise the electrical transmission or distribution systems under surveillance is gathered and analysed at regular intervals. Over time, the collected data may be analysed to detect developing trends in the data, which may provide early indications that a particular asset is beginning to degrade or fail and requires maintenance or replacement. For example, not intending to be limiting, each sensor device may be configured to sample and record the audio signals emitted by the adjacent asset at a regular time interval, such as every five or ten minutes, and the signal may be recorded for a period of time, such as one second. Next, the edge computing device transforms the recorded audio signal into a 2D spectrogram, for example by using a fast Fourier transform. The edge computing device then applies the encoder component of the autoencoder model to the 2D spectrogram, to transform the 2D spectrogram into a series of latent variables representing the features included in the original data sample, with the last layer of the encoder producing the binary representation of those latent variables so as to compress that data for efficient transmission to the remote computing system. The binary representation, being a compressed signal, is then transmitted, for example over a wireless or wired network, to the centralized server of the remote computing system for additional processing. In a preferred embodiment, all data samples recorded by a sensor device and encoded by an edge computing device are transmitted to the remote computing system for processing, thereby generating a data set pertaining to the condition of each asset of the plurality of electrical assets over time.

In some embodiments of the present disclosure, the classification of the latent variable space of a regenerated spectrogram, to identify and label the condition of a given asset, may then lead to the generating of recommendations for maintenance of that asset, based on the classification of the latent variable space of the regenerated spectrogram and the resulting identification of the condition of that asset. In other embodiments, the monitoring of the plurality of assets over time may result in the early identification of developing faults on a given asset, which may lead to recommendations for preventative maintenance of such assets before a fault, such as a corona discharge or a physical failure of the asset, occurs. In one aspect of the present disclosure, monitoring of each asset over an extended period of time, on the order of several months or years, may allow for prioritization of the generated maintenance recommendations, taking factors into account such as the severity or criticality of a detected condition of an asset, the location of the asset, the proximity of a number of assets to one another requiring maintenance, and the scope of the potential impact on customers should the asset fail.

Advantageously, valuable information may be derived from the periodic sampling of each electrical asset, as gradual or sudden changes in the audio signal data samples of a given electrical asset may indicate changes in the condition of that asset. As well, in the case of a catastrophic failure of a given asset, such events may be detected by the absence of a binary representation transmitted to the centrally located server, as under normal operating conditions, the edge computing device would have transmitted such a binary representation at the pre-determined time intervals, which may for example occur every five or ten minutes.

In some embodiments of the present disclosure, the audio signals emitted by an asset may be recorded by the sensor device at pre-determined intervals, such as, taking a one second recording of the sound signals emitted by the asset every five minutes. Frequently recording the audio signals, for a short duration, of many assets over a period of months or years may generate a large data set that may be used to continually train and refine the autoencoder and classifier models, resulting in improved classification accuracy over time. This sampling approach may be appropriate for systems in which the edge computing devices face power constraints; for example, where each edge computing device is powered by a battery and a small solar panel. However, in systems without such power constraints, such as edge computing devices that are powered by power harvesting devices capable of harvesting electricity from the electrical transmission lines, sampling the audio signals with increased frequency and recording duration may be desirable for obtaining larger data sets, as well as increasing the likelihood that an anomaly in the audio signals, emitted by the infrastructure assets, will be captured by the sensor device. In systems where the edge computing device has no power constraints, continuous sampling and monitoring of the infrastructure assets may be provided.

Although the present disclosure describes monitoring remote electrical infrastructure using the methods and systems disclosed herein, the Applicant notes that the methods and systems disclosed herein may be applied to monitoring other types of infrastructure assets which emit audio signals, and these audio signals may be analysed to detect defects or faults developing in the infrastructure asset being monitored. For example, not intended to be limiting, such methods and systems may be applied to monitoring the status of electrical distribution infrastructure, electrical generation infrastructure, electrical substation infrastructure, transportation infrastructure such as tunnels, roadways, overpasses, bridges and roadway lighting systems, traffic control systems, pipeline infrastructure, oil and gas infrastructure and railway systems.

In some embodiments of the present disclosure, the microphone of the sensor device includes a microphone array, including two or more microphones, whereby each microphone in the array is positioned in a different direction to capture audio signals emitted by specific sub-components of an asset being monitored. For example, this may occur where a sensor device is mounted to a transmission line pole supporting three sub-conductors, in which case the sensor device may include a microphone array of three microphones, each microphone positioned to sample and record audio signals emitted by one sub-conductor in the bundle of sub-conductors. In such configurations of sensor devices, the sensor device may capture three different signals and three different data sets during each sampling period, and the subsequent transformation and data processing steps are performed by the edge computing device on each of the three audio signals recorded by the sensor device.

In some embodiments, the sensor device and the edge computing device are contained within the housing of a single unit; however, it will be appreciated by a person skilled in the art that the sensor device and the edge computing device may be separate components located proximate to one another and that this is not intended to be limiting.

1-19. (canceled)

20. A method for detecting a condition on infrastructure, the infrastructure comprising a plurality of assets, the method comprising:
obtaining recorded audio signals emitted by an asset for further processing by an edge computing device mounted proximate to the asset;
transforming the recorded audio signals to generate a spectrogram, the transforming step performed by the edge computing device;
encoding the spectrogram to generate a binary feature representation of the recorded audio signal, the encoding step performed by the edge computing device using an encoder component of an autoencoder, wherein a decoder component of the autoencoder is located on a remote computing system located remotely from the asset;
transmitting the binary feature representation to the remote computing system;
decoding the binary feature representation to regenerate the spectrogram, the decoding step performed by the remote computing system using the decoder component of the autoencoder;
classifying a latent variable space of the regenerated spectrogram to detect whether the recorded audio signals indicate a condition of the said asset, wherein the classifying step is performed by a classifier hosted on the remote computing system.

21. The method of claim 20, wherein the step of encoding the spectrogram to generate a binary feature representation further includes the encoder converting the spectrogram into the latent variable space, the latent variable space representing features of the recorded audio signals, and then the encoder encodes the latent variable space into the said binary feature representation.

22. The method of claim 21, further comprising a step of training the autoencoder on the remote computing system using a data set, the data set comprising a plurality of audio signal recordings obtained from the plurality of assets.

23. The method of claim 22, further comprising a step of training the classifier using the data set, wherein each audio signal recording of the plurality of audio signal recordings is labelled with a condition of interest, the condition of interest indicating a condition of the asset that emitted the audio signal.

24. The method of claim 23, wherein the step of training the autoencoder generates a plurality of autoencoder models for encoding and decoding the audio signal and wherein the step of training the classifier generates a plurality of classifier models, and wherein, after performing the steps of training the autoencoder and training the classifier, performing a validation step wherein the autoencoder and the classifier are trained together on the data set to identify a combination of an autoencoder model of the plurality of autoencoder models and a classifier model of the plurality of classifier models that produces a most accurate identification of the condition of the asset emitting the audio signal.

25. The method of claim 22 wherein after the step of training the autoencoder, the encoder component of the autoencoder is deployed on the edge computing device and the decoder component of the autoencoder is deployed on the remote computing system.

26. The method of claim 23 wherein the remote computing system comprises a training server and a deployment server, and wherein the steps of training the autoencoder and training the classifier are performed on the training server, and wherein the decoder component of the autoencoder and the classifier are deployed on the deployment server.

27. The method of claim 20 wherein the autoencoder comprises a first series of convolutional neural networks (CNNs).

28. The method of claim 27 wherein the classifier comprises a second series of CNNs.

29. The method of claim 20 wherein the asset is selected from a group of electrical infrastructure assets, the group comprising: switch-gear, insulator, conductor, sub-conductor.

30. The method of claim 23 wherein the condition of interest is selected from a group comprising: physical failure, corona discharge, partial discharge, arcing, flashover, pollution, nominal condition.

31. The method of claim 20 wherein the infrastructure is selected from a group comprising: electrical transmission infrastructure, electrical distribution infrastructure, electrical generation infrastructure, electrical substation infrastructure, transportation infrastructure, tunnels, roadways, overpasses, bridges, roadway lighting systems, traffic control systems, pipeline infrastructure, oil and gas infrastructure, railway systems.

32. The method of claim 20 wherein the step of transmitting the binary feature representation to the remote computing system comprises transmitting the binary feature representation by a low-power wireless transmitter over a wireless network.

33. The method of claim 20 wherein the method further comprises a step of generating a recommendation for maintenance of the asset based upon the classification of the latent variable space of the regenerated spectrogram.

34. The method of claim 20 wherein the method further comprises the steps of generating a recommendation for maintenance of each asset of the plurality of assets based upon the classification of the latent variable space of the regenerated spectrogram so as to generate a plurality of recommendations for maintenance of the plurality of assets; and ranking the plurality of recommendations for maintenance to prioritize the recommendations based on an assessed criticality of the identified condition of each asset of the plurality of assets.

35. The method of claim 34 wherein the method further comprises a step of implementing the prioritized maintenance recommendations on the identified assets of the plurality of assets.

36. A system for detecting a condition on infrastructure, the infrastructure comprising a plurality of assets, the system comprising:
a sensor device mounted proximate to the asset, the sensor device configured to record audio signals emitted by an asset of the plurality of assets;
an edge computing device mounted proximate to the asset, the edge computing device configured to transform the recorded audio signals into a spectrogram and then encode the spectrogram to generate a binary feature representation of the recorded audio signal using an encoder component of an autoencoder;
a remote computing system located remotely from the asset, the remote computing system configured to receive the binary feature representation transmitted from the edge computing device over a network and then decode the binary feature representation to regenerate the spectrogram, the decoding step performed by the remote computing system using the decoder component of the autoencoder;
the remote computing system additionally configured to classify a latent variable space of the regenerated spectrogram to identify whether the recorded audio signals indicate a condition of the asset, wherein the classifying step is performed by a classifier hosted on the remote computing system.

37. The system of claim 36 wherein the encoder converts the spectrogram into the latent variable space, the latent variable space representing features of the recorded audio signals, and then the encoder encodes the latent variable space into the binary feature representation.

38. The system of claim 36 wherein the autoencoder comprises a first series of neural networks (CNNs) and wherein the encoder component of the autoencoder contains fewer CNNs than the decoder component of the autoencoder.

39. The system of claim 38 wherein the classifier comprises a second series of CNNs.

40. The system of claim 36 wherein the remote computing system comprises a training server and a deployment server, and wherein the training of the autoencoder is performed on the training server and the decoder component of the autoencoder and the classifier are deployed on the deployment server.

41. The system of claim 36 wherein the edge computing device comprises a low-power wireless transmitter, and wherein the binary feature representation is transmitted to the remote computing system by the low-power wireless transmitter over a wireless network.

42. The system of claim 36 wherein the sensor device comprises: a microphone for receiving the audio signals and a memory for recording the received audio signals.

43. (canceled)

44. The system of claim 42 wherein the microphone comprises a microphone array, and wherein each microphone in the microphone array is configured to receive an audio signal emitted by a sub-component of the asset.

45. The method of claim 20, wherein the step of obtaining recorded audio signals emitted by an asset includes recording audio signals emitted by the asset using a sensor device mounted proximate to the asset.
